(19) United States
(12) Patent Application Publication
(10) Pub. No.: US 2020/0273058 A1
(43) Pub. Date: Aug. 27, 2020

(54) Determining Loyalty Program Account at a Point-of-Sale Device

(71) Applicant: Visa International Service Association, San Francisco, CA (US)

(72) Inventors: Michael Kenji Mori, San Mateo, CA (US); Rajat Das, Foster City, CA (US)

(21) Appl. No.: 16/284,131

(22) Filed: Feb. 25, 2019

(51) Int. Cl. G06Q 30/02

(52) U.S. Cl. CPC G06Q 30/0225; G06Q 30/0238; G06Q 30/0226

(57) ABSTRACT

Provided is a computer-implemented method for determining a loyalty program account at a point-of-sale (POS) device comprising receiving payment transaction data associated with a payment transaction between a user and a merchant, identifying a loyalty program provider associated with the merchant based on receiving merchant identification data associated with an identification of the merchant included in the payment transaction data, determining a user identifier identifying a loyalty program account based on a payment account number of a payment account, communicating a request for validation of the loyalty program account, the request for validation including the user identifier, receiving an indication that the loyalty program account of the user is valid and loyalty program account information associated with the loyalty program account of the user, and processing the payment transaction between the user and the merchant. A system and computer program product are also disclosed.

### BACKGROUND

### 1. Technical Field

This disclosure relates generally to transaction processing and, In some non-limiting aspects or embodiments, to systems, methods, and computer program products for associating transactions with loyalty program accounts during a transaction.

### 2. Technical Considerations

Loyalty program accounts have been developed by loyalty program providers to assist merchants in adjusting transaction prices during transactions to encourage sales of goods and/or services. However, before a loyalty program account may be used to adjust a transaction price, the loyalty program account may first be associated with a transaction. This association is generally performed via a two-step process: first, by receiving and associating loyalty program account information with the transaction at a point-of-sale (POS) terminal; and second, by receiving and associating payment account information with the transaction. Both steps may include an individual presenting two separate devices (e.g., a loyalty program provider card and a payment card) to communicate two different sets of information at the POS terminal.

For example, a point-of-sale (POS) device such as an automated fuel dispenser (AFD) may read an identifier displayed on a loyalty program account device (e.g., a barcode on a loyalty card) corresponding to a loyalty program account maintained by a loyalty program provider. The AFD device may then read a primary account number (PAN) from a payment device, the PAN associated with an account maintained by an issuer institution. Based on the status of the loyalty program account, the AFD may adjust the price of fuel dispensed during the transaction and determine a final sale price for settlement of the transaction. In such an example, the time required for the user to present the loyalty program account device may require an amount of time that is undesirable to the user and/or to other individuals at the merchant location waiting to conduct transactions with the AFD device. In addition, customers may fraudulently use a loyalty program account device to obtain a discount not intended for the user. For example, by using a loyalty program account device associated with a different user in violation of policies set by the merchant).

### SUMMARY

Accordingly, systems, devices, products, apparatus, and/or methods for determining a loyalty program account at a point-of-sale (POS) device are disclosed that overcome some or all of the deficiencies of the prior art.

According to a non-limiting aspect or embodiment, provided is a computer implemented method for determining a loyalty program account at a POS device. The method may comprise: receiving, with at least one processor, payment transaction data associated with a payment transaction during the payment transaction between a user and a merchant identifying, with at least one processor, a loyalty program provider associated with the merchant based on receiving merchant identification data associated with an identification of the merchant included in the payment transaction data associated with the payment transaction; determining, with at least one processor, a user identifier that identifies a loyalty program account of the user based on a payment account number of a payment account of the user included in the payment transaction data associated with the payment transaction; communicating, with at least one processor, a request for validation of the loyalty program account of the user based on identifying the loyalty program provider associated with the merchant, the request for validation including the user identifier; receiving, with at least one processor, an indication that the loyalty program account of the user is valid and loyalty program account information associated with the loyalty program account of the user based on the request for validation of the loyalty program account of the user; and processing, with at least one processor, the payment transaction between the user and the merchant based on the loyalty program account information associated with the loyalty program account of the user.

In another non-limiting aspect or embodiment, provided is a system for determining a loyalty program account at a POS device. The system may comprise at least one processor programmed or configured to: receive payment transaction data associated with a payment transaction during the payment transaction between a user and a merchant, identify a loyalty program provider associated with the merchant based on receiving merchant identification data associated with an identification of the merchant included in the payment transaction data associated with the payment transaction, determine a user identifier that identifies a loyalty program account of the user based on a payment account number of a payment account of the user included in the payment transaction data associated with the payment transaction, communicate a request for validation of the loyalty program account of the user based on identifying the loyalty program provider associated with the merchant, the request for validation including the user identifier, receive an indication that the loyalty program account of the user is valid and loyalty program account information associated with the loyalty program account of the user based on the request for validation of the loyalty program account of the user, and process the payment transaction between the user and the merchant based on the loyalty program account information associated with the loyalty program account of the user.

According to another non-limiting aspect or embodiment, provided is a computer program product for determining a loyalty program account at a POS device. The computer program product comprises at least one non-transitory computer-readable medium including one or more instructions that, when executed by at least one processor, cause the at least one processor to: receive payment transaction data associated with a payment transaction during the payment transaction between a user and a merchant, identify a loyalty program provider associated with the merchant based on receiving merchant identification data associated with an identification of the merchant included in the payment transaction data associated with the payment transaction, determine a user identifier that identifies a loyalty program account of the user based on a payment account number of a payment account of the user included in the payment transaction associated with the payment transaction, communicate a request for validation of the loyalty program account of the user based on identifying the loyalty program provider associated with the merchant, the request for validation including the user identifier, receive an indication that the loyalty program account of the user is valid and loyalty program account information associated with the loyalty program account of the user based on the request for validation of the loyalty program account of the user, and process the payment transaction between the user and the merchant based on the loyalty program account information associated with the loyalty program account of the user.

Further aspects or embodiments are set forth in the following numbered clauses:

Clause 1: A computer-implemented method for determining a loyalty program account at a point-of-sale (POS) device, the method comprising: receiving, with at least one processor, payment transaction data associated with a payment transaction during the payment transaction between a user and a merchant; identifying, with at least one processor, a loyalty program provider associated with the merchant based on receiving merchant identification data associated with an identification of the merchant included in the payment transaction data associated with the payment transaction; determining, with at least one processor, a user identifier that identifies a loyalty program account of the user based on a payment account number of a payment account of the user included in the payment transaction data associated with the payment transaction; communicating, with at least one processor, a request for validation of the loyalty program account of the user based on identifying the loyalty program provider associated with the merchant, the request for validation including the user identifier; receiving, with at least one processor, an indication that the loyalty program account of the user is valid and loyalty program account information associated with the loyalty program account of the user based on the request for validation of the loyalty program account of the user; and processing, with at least one processor, the payment transaction between the user and the merchant based on the loyalty program account information associated with the loyalty program account of the user.

Clause 2: The method according to clause 1, further comprising: receiving the user identifier that identifies the loyalty program account of the user from a user device associated with the user before the payment transaction between the user and the merchant; assigning the user identifier that identifies the loyalty program account of the user to the payment account number of the payment account of the user; and storing the user identifier that identifies the loyalty program account of the user with the payment account number of the payment account of the user in a database.

Clause 3: The method according to clauses 1 or 2, wherein the user is a first user, the method further comprising: determining that a loyalty program account of a second user is not available based on receiving the payment transaction data associated with a payment transaction; and communicating a message to a merchant system, wherein the message comprises a first indication that a loyalty program account of the second user is not available and a second indication that includes enrollment information associated with establishing a loyalty program account of the second user.

Clause 4: The method according to any of clauses 1-3, wherein determining the user identifier that identifies the loyalty program account of the user comprises: determining the user identifier that identifies the loyalty program account of the user independent of information associated with an input received based on a manual input component of a POS device.

Clause 5: The method according to any of clauses 1-4, further comprising: receiving an indication that the loyalty program account of the user is not valid based on the request for validation of the loyalty program account of the user; and processing the payment transaction between the user and the merchant independent of the loyalty program account information associated with the loyalty program account of the user.

Clause 6: The method according to any of clauses 1-5, wherein processing the payment transaction between the user and the merchant comprises: communicating an authorization request message to an issuer system, wherein the authorization request message is independent of the loyalty program account information associated with the loyalty program account of the user.

Clause 7: The method according to any of clauses 1-6, further comprising: receiving an indication that the loyalty program account of the user is not valid based on the request for validation of the loyalty program account of the user; and declining to process the payment transaction between the user and the merchant based on receiving the indication that the loyalty program account of the user is not valid.

Clause 8: A system for determining a loyalty program account at a point-of-sale (POS) device, the system comprising: at least one processor programmed or configured to: receive payment transaction data associated with a payment transaction during the payment transaction between a user and a merchant; identify a loyalty program provider associated with the merchant based on receiving merchant identification data associated with an identification of the merchant included in the payment transaction data associated with the payment transaction; determine a user identifier that identifies a loyalty program account of the user based on a payment account number of a payment account of the user included in the payment transaction data associated with the payment transaction; communicate a request for validation of the loyalty program account of the user based on identifying the loyalty program provider associated with the merchant, the request for validation including the user identifier; receive an indication that the loyalty program account of the user is valid and loyalty program account information associated with the loyalty program account of the user based on the request for validation of the loyalty program account of the user; and process the payment transaction between the user and the merchant based on the loyalty program account information associated with the loyalty program account of the user.

Clause 9: The system according to clause 8, wherein the at least one processor is further programmed or configured to: receive the user identifier that identifies the loyalty program account of the user from a user device associated with the user before the payment transaction between the user and the merchant; assign the user identifier that identifies the loyalty program account of the user to the payment account number of the payment account of the user; and store the user identifier that identifies the loyalty program account of the user with the payment account number of the payment account of the user in a database.

Clause 10: The system according to clauses 8 or 9, wherein, the user is a first user, and the at least one processor is programmed or configured to: determine that a loyalty program account of a second user is not available based on receiving the payment transaction data associated with a payment transaction; and communicate a message to a merchant system, wherein the message comprises a first indication that a loyalty program account of the second user is not available and a second indication that includes enrollment information associated with establishing a loyalty program account of the second user.

Clause 11: The system according to any of clauses 8-10, wherein, when determining the user identifier that identifies the loyalty program account of the user, the at least one processor is programmed or configured to: determine the user identifier that identifies the loyalty program account of the user independent of information associated with an input received based on a manual input component of a POS device.

Clause 12: The system according to any of clauses 8-11, wherein the at least one processor is programmed or configured to: receive an indication that the loyalty program account of the user is not valid based on the request for validation of the loyalty program account of the user; and process the payment transaction between the user and the merchant independent of the loyalty program account information associated with the loyalty program account of the user.

Clause 13: The system according to any of clauses 8-12, wherein, when processing the payment transaction between the user and the merchant, the at least one processor is programmed or configured to: communicate an authorization request message to an issuer system, wherein the authorization request message is independent of the loyalty program account information associated with the loyalty program account of the user.

Clause 14: The system according to any of clauses 8-13, wherein the at least one processor is programmed or configured to: receive an indication that the loyalty program account of the user is not valid based on the request for validation of the loyalty program account of the user; and decline to process the payment transaction between the user and the merchant based on receiving the indication that the loyalty program account of the user is not valid.

Clause 15: A computer program product for determining a loyalty program account at a point-of-sale (POS) device, comprising at least one non-transitory computer-readable medium including one or more instructions that, when executed by at least one processor, cause the at least one processor to: receive payment transaction data associated with a payment transaction during the payment transaction between a user and a merchant; identify a loyalty program provider associated with the merchant based on receiving merchant identification data associated with an identification of the merchant included in the payment transaction data associated with the payment transaction; determine a user identifier that identifies a loyalty program account of the user based on a payment account number of a payment account of the user included in the payment transaction associated with the payment transaction; communicate a request for validation of the loyalty program account of the user based on identifying the loyalty program provider associated with the merchant, the request for validation including the user identifier; receive an indication that the loyalty program account of the user is valid and loyalty program account information associated with the loyalty program account of the user based on the request for validation of the loyalty program account of the user; and process the payment transaction between the user and the merchant based on the loyalty program account information associated with the loyalty program account of the user.

Clause 16: The computer program product according to clause 15, wherein the one or more instructions, when executed by the at least one processor, further cause the at least one processor to: receive the user identifier that identifies the loyalty program account of the user from a user device associated with the user before the payment transaction between the user and the merchant; assign the user identifier that identifies the loyalty program account of the user to the payment account number of the payment account of the user; and store the user identifier that identifies the loyalty program account of the user with the payment account number of the payment account of the user in a database.

Clause 17: The computer program product according to clauses 15 or 16, wherein the user is a first user, and wherein the one or more instructions, when executed by the at least one processor, further cause the at least one processor to: determine that the loyalty program account of a second user is not available based on receiving the payment transaction data associated with the payment transaction; and communicate a message to a merchant system, wherein the message comprises a first indication that a loyalty program account of the second user is not available and a second indication that includes enrollment information associated with establishing the loyalty program account of the second user.

Clause 18: The computer program product according to any of clauses 15-17, wherein the one or more instructions that cause the at least one processor to receive data, cause the at least one processor to: determine the user identifier that identifies the loyalty program account of the user independent of information associated with an input received based on a manual input component of a POS device.

Clause 19: The computer program product according to any of clauses 15-18, wherein the one or more instructions, when executed by the at least one processor, further cause the at least one processor to: receive an indication that the loyalty program account of the user is not valid based on the request for validation of the loyalty program account of the user; and process the payment transaction between the user and the merchant independent of the loyalty program account information associated with the loyalty program account of the user.

Clause 20: The computer program product according to any of clauses 15-19, wherein the one or more instructions that cause the at least one processor to process the payment transaction between the user and the merchant cause the at least one processor to: communicate an authorization request message to an issuer system, wherein the authorization request message is independent of the loyalty program account information associated with the loyalty program account of the user.

Clause 21: The computer program product according to any of clauses 15-20, wherein the one or more instructions, when executed by the at least one processor, further cause the at least one processor to: receive an indication that the loyalty program account of the user is not valid based on the request for validation of the loyalty program account of the user; and decline to process the payment transaction between the user and the merchant based on receiving the indication that the loyalty program account of the user is not valid.

The features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the scope of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying schematic figures, in which:

FIG. 1 is a diagram of a non-limiting embodiment of a system for determining a loyalty program account at a point-of-sale (POS) device;

FIG. 2 is a diagram of a non-limiting embodiment of components of one or more components of one or more devices illustrated by FIG. 1;

FIG. 3 is a flow diagram of a process for determining loyalty program account at a POS device; and

FIG. 4 is a diagram of an implementation of non-limiting aspects or embodiments of the process shown in FIG. 3.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the illustrated embodiments are not to be interpreted as limiting and may assume various alternative variations and step sequences, except where expressly specified to the contrary. It is also to be understood that the specific devices and processes illustrated in the attached drawings, and described in the following specification, are simply exemplary embodiments or aspects of the present disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting aspects or embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “communicate” may refer to the reception, receipt, transmission, transfer, provision, and/or the like of information (e.g., data, signals, messages, instructions, commands, and/or the like). As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting aspects or embodiments, a message may refer to a packet (e.g., a data packet, a network packet, and/or the like) that includes data.

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting aspects or embodiments, a transaction service provider system may include one or more servers operated by or operated on behalf of a transaction service provider.

As used herein, the term “issuer” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions). For example, an issuer may provide an account identifier, such as a primary account number (PAN), an international bank account number (IBAN), and/or the like to a user that uniquely identifies one or more accounts associated with the user. The account identifier may be used by the user to conduct a payment transaction. In some non-limiting aspects or embodiments, the account identifier may be embodied on a portable financial device, such as a physical financial instrument (e.g., a payment card) and/or may be electronic and used for electronic payments. In some non-limiting aspects or embodiments, an issuer may be associated with a bank identification number (BIN) that uniquely identifies the issuer. As used herein “issuer system” may refer to one or more systems operated by or operated on behalf of an issuer. For example, an issuer system may refer to a server executing one or more software applications associated with the issuer. In some non-limiting aspects or embodiments, an issuer system may include one or more servers (e.g., one or more authorization servers) for authorizing a payment transaction.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting aspects or embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting aspects or embodiments, an acquirer may be a financial institution, such as a bank.

As used herein, the term “merchant” may refer to one or more entities (e.g., one or more operators of retail businesses, one or more retailers, and/or the like) that provide goods and/or services to a user based on a payment transaction between the one or more entities and the user. As used herein “merchant system” may refer to one or more systems operated by or operated on behalf of a merchant, such as a server executing one or more software applications associated with the merchant.

As used herein, the term “account identifier” may refer to one or more types of identifiers associated with an account (e.g., a unique identifier of an account, an account number, a PAN, a card number, a payment card number, a token, and/or the like) of a user. In some non-limiting aspects or embodiments, an issuer may provide an account identifier to a user that uniquely identifies one or more accounts associated with that user. In some non-limiting aspects or embodiments, an account identifier may be embodied on a physical financial instrument (e.g., a portable financial device, a payment card, a credit card, a debit card, and/or the like) and/or may be electronic information communicated to the user that the user may use for electronic payment transactions. In some non-limiting aspects or embodiments, an account identifier may be an original account identifier, where the original account identifier was provided to a user at the creation of the account associated with the account identifier. In some non-limiting aspects or embodiments, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting aspects or embodiments, an account identifier may be directly or indirectly associated with an issuer such that an account identifier may be a token that maps to a PAN or other type of identifier. Account identifiers may be alphanumeric, any combination of characters and/or symbols, and/or the like.

As used herein, the term “account token” may refer to an identifier that is used as a substitute or replacement identifier for an account identifier, such as a PAN. An account token may be used as a substitute or replacement identifier for an original account identifier, such as a PAN. Account tokens may be associated with a PAN or other original account identifier in one or more data structures (e.g., one or more databases and/or the like) such that they may be used to conduct a transaction without directly using the original account identifier. In some non-limiting aspects or embodiments, an original account identifier, such as a PAN, may be associated with a plurality of account tokens for different individuals or purposes. In some non-limiting aspects or embodiments, account tokens may be associated with a PAN or other account identifiers in one or more data structures such that they can be used to conduct a transaction without directly using the account identifier, such as a PAN. In some examples, an account identifier, such as a PAN, may be associated with a plurality of account tokens for different uses or different purposes.

As used herein, the term “computing device” may refer to one or more electronic devices that include one or more processors and/or integrated circuits. A computing device may be a stationary computer (e.g., a desktop computer) or a mobile device. As an example, a mobile device may include a cellular phone (e.g., a smartphone or standard cellular phone), a portable computer (e.g., a laptop), a wearable device (e.g., watches, glasses, lenses, clothing, and/or the like), a personal digital assistant (PDA), and/or other like devices. A computing device may also include components to send, receive, and/or process data such as, but not limited to, memory, a display device, an input device, a network interface, and/or the like.

As used herein, the term “payment device” may refer to a payment card, such as a credit card, a debit card, a charge card, a gift card, a smartcard, a payroll card, and/or the like, associated with an account identifier of a payment account. In some non-limiting aspects or embodiments, the payment device may include volatile and/or non-volatile memory to store information (e.g., an account identifier, a name of the account holder, and/or the like). A payment device may also include a user device having an electronic wallet thereon.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “server” may refer to or include one or more processors or computing devices, storage devices, or similar computer arrangements that are operated by or facilitate communication and processing for multiple parties in a network environment, such as the Internet, although it will be appreciated that communication may be facilitated over one or more public or private network environments and that various other arrangements are possible. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or processor recited as performing a second step or function.

As used herein, the term “system” may refer to one or more devices, such as one or more processors, servers, and/or computing devices that include software applications, and/or the like.

Non-limiting aspects or embodiments of the present disclosure are directed to systems, methods, and computer program products for determining a loyalty program account at a point-of-sale (POS) device. According to some non-limiting aspects or embodiments, customers or users engaging with POS devices during transactions with a payment device that that is pre-associated with a loyalty program account. As a result, the amount of time necessary to conduct payment transactions associated with loyalty program accounts may be reduced given that the user only presents a single physical device during the transaction (e.g., the payment device). This reduction in transaction time enables the user to complete other tasks during the transaction faster (e.g., enables the user to start the fuel dispensing process faster at an AFD) and, by extension, enable subsequent users to engage with the POS device quicker. Additionally or alternatively, fraudulent or unintended association of a loyalty program account with a particular transaction may be reduced or eliminated since, by virtue some aspects or features described herein, the loyalty program account may only be used by a user in control of a payment device. This association of the loyalty program account with the payment device may also include the individual associated with the loyalty program account being responsible for payment during the transaction, reducing the likelihood a user not associated with the payment device would be permitted to engage in such a transaction.

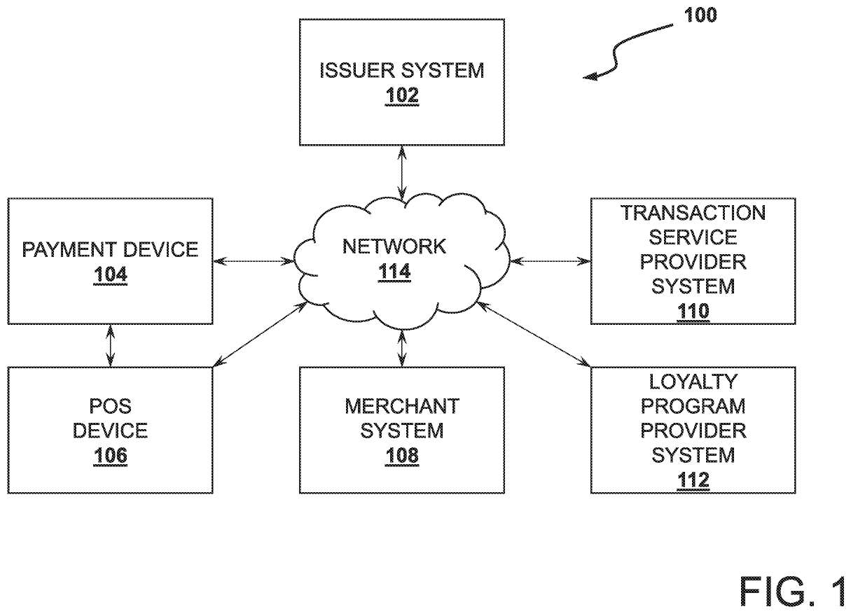

Referring now to FIG. 1, illustrated is a diagram of a non-limiting aspect or embodiment of a system 100 for determining a loyalty program account at a POS device. The system 100 includes an issuer system 102, a payment device 104, a POS device 106, a merchant system 108, a transaction service provider system 110, and a loyalty program provider system 112. The issuer system 102, payment device 104, POS device 106, merchant system 108, transaction service provider system 110, and/or loyalty program provider system 112 may interconnect (e.g., establish a connection to directly or operably communicate) via wired connections, wireless connections, or a combination of wired and wireless connections, to any or all of the corresponding components of the system 100. In some non-limiting aspects or embodiments, operable communication may be established between the devices of the system 100 by communicating via an intermediate device or system.

With continued reference to FIG. 1, the issuer system 102 may include one or more devices capable of communicating information to and/or from the payment device 104, POS device 106, merchant system 108, transaction service provider system 110, and/or loyalty program provider system 112 via the network 114. For example, the issuer system 102 may include one or more computing devices, such as a server (e.g., a server configured to process transactions), a group of servers, and/or other similar devices. In some non-limiting aspects or embodiments, the issuer system 102 may be associated with an issuer that issued a credit account, debit account, credit card, debit card, and/or the like to a user associated with the payment device 104.

The payment device 104 may include one or more devices capable of communicating information to and/or from the issuer system 102, POS device 106, merchant system 108, transaction service provider system 110 and/or loyalty program provider system 112 via the network 114. For example, the payment device 104 may include a payment device (e.g., a credit card, debit card, gift card, etc.). In some non-limiting aspects or embodiments, the payment device 104 may include a user device. In some non-limiting aspects or embodiments, the user device may include one or more computing devices (e.g., a computing device such as a mobile device (e.g., a smartphone or wearable device that are configured to maintain an electronic wallet). In some non-limiting aspects or embodiments, the payment device 104 may interconnect (e.g., establish a connection to communicate) with the POS device 106 and/or the merchant system 108 via wired connections, wireless connections, or a combination of wired and wireless connections. In some non-limiting aspects or embodiments, the payment device 104 may be part of the POS device 106 and/or the merchant system 108, such as one or more components of a point-of-sale (POS) system. In some non-limiting aspects or embodiments, the payment device 104 may be capable of receiving information (e.g., from the POS device 106, the merchant system 108, and/or the transaction service provider system 110, etc.) via a short range wireless communication connection (e.g., a NFC connection, a radio frequency identification (RFID) communication connection, a Bluetooth® communication connection, and/or the like) or any other form of communication (e.g., a communication routed through a hub or server). The payment device 104 may be associated with and/or controlled by a party to a transaction such as a user or entity associated with a credit account, debit account, credit card, debit card, and/or the like.

The POS device 106 may include one or more devices capable of communicating information to and/or from the issuer system 102, payment device 104, merchant system 108, transaction service provider system 110 and/or loyalty program provider system 112 via the network 114 and/or via a local connection (e.g., a short range wireless communication connection such as a NFC connection, a RFID communication connection, a Bluetooth® communication connection, and/or the like). For example, the POS device 106 may include a physical device, one or more computing devices, portable computers, tablet computers, cellular phones, smartphones, wearable devices (e.g., watches, glasses, lenses, clothing and/or the like), PDAs, and/or the like. In some non-limiting aspects or embodiments, the POS device 106 may be capable of transmitting and/or receiving information (e.g., from the payment device 104 and/or the merchant system 108) via a short range wireless communication connection (e.g., NFC connection, a RFID communication connection, a Bluetooth® communication connection, and/or the like) and/or communicating information (e.g., to the payment device 104 and/or the merchant system 108) via a short range wireless communication connection.

The merchant system 108 may include one or more systems or devices capable of communicating information to and/or from the issuer system 102, payment device 104, POS device 106, transaction service provider system 110, and/or the loyalty program provider system 112 via the network 114. For example, the merchant system 108 may include one or more computing devices, such as one or more servers, one or more POS systems, and/or other like systems or devices. In some non-limiting aspects or embodiments, the merchant system 108 may include a device capable of communicating and/or receiving information from the payment device 104 and/or the POS device 106 via a network (e.g., the network 114) and/or a wireless communication connection (e.g., a NFC connection, a RFID communication connection, a Bluetooth® communication connection, and/or the like). In some non-limiting aspects or embodiments, the merchant system 108 may include one or more POS devices 106 and/or payment device 104. For example, the merchant system 108 may include payment device 104 and/or POS devices 106 that allow a merchant to communicate information to and/or from the transaction service provider system 110 and/or the loyalty program provider system 112. In some non-limiting aspects or embodiments, the merchant system 108 may communicate with the transaction service provider system 110 to process a transaction and, more particularly, initiate a transaction by transmitting a transaction authorization request generated during a transaction to the transaction service provider system 110. In some non-limiting aspects or embodiments, the merchant system 108 may communicate transaction data to the transaction service provider system 110, including transaction parameters associated with transactions initiated by the payment device 104. Non-limiting examples of transaction parameters include a primary account number (PAN), a transaction amount, a transaction date and/or time, a conversion rate of currency, a merchant type, a merchant identification number, a type of currency, and/or the like. The merchant system 108 may receive a response code from the transaction service provider system 110 including an indication that the transaction is approved and/or disapproved, stolen, not to be honored, partially approved, approved for an amount not to exceed a maximum permitted amount, is associated with an account having insufficient funds, included an incorrect PIN, and/or the like. In some non-limiting aspects or embodiments, the transaction parameters may be stored in a database associated with the merchant system 108 and/or the transaction service provider system 110. In some non-limiting aspects or embodiments, the merchant system 108 may include one or more devices, such as computers, computing devices, computer systems, and/or peripheral devices capable of being used by a merchant to conduct a payment transaction with a user.

The transaction service provider system 110 may include one or more devices capable of communicating information to and/or from the issuer system 102, payment device 104, POS device 106, merchant system 108, and/or the loyalty program provider system 112 via the network 114. For example, the transaction service provider system 110 may include one or more computing devices, such as a server, a group of servers, and/or other like devices. In some non-limiting aspects or embodiments, the transaction service provider system 110 may be associated with a financial institution (e.g., an issuer institution) and/or a transaction service provider as described herein. The transaction service provider system 110 may include data processing subsystems, networks, and/or operations used to support and deliver certificate authority services, authorization services, exception file services, and clearing and settlement services. In some non-limiting aspects or embodiments, transaction service provider systems 110 may be configured to process credit card transactions, debit card transactions, and other types of commercial transactions. At the end of a business day, the transaction service provider system 110 may participate in and/or conduct a clearing and settlement process to exchange financial details between the merchant system 108, the transaction service provider system 110, and/or the issuer system 102. As a result of the clearing and settlement process, payments made from accounts maintained either by the issuer system 102, the transaction service provider system 110, and/or the merchant system 108 may be reconciled. In some non-limiting aspects or embodiments, the payments made are transmitted to an acquirer system associated with the merchant.

The loyalty program provider system 112 may include one or more devices capable of communicating information to and/or from the issuer system 102, payment device 104, POS device 106, merchant system 108, and/or the transaction service provider system 110 via the network 114. For example, the loyalty program provider system 112 may include one or more computing devices, such as a server, a group of servers, and/or other like devices. In some non-limiting aspects or embodiments, the loyalty program provider system 112 may be associated with a financial institution (e.g., an issuer institution) and/or a transaction service provider as described herein. In some non-limiting aspects or embodiments, the loyalty program provider system 112 may be associated with a loyalty program provider that maintains one or more loyalty program accounts. In some non-limiting aspects or embodiments, loyalty program accounts may include loyalty program account information used to track transaction data and/or transaction adjustment data (e.g., a percent reduction from a stated price to be applied during and/or after the transaction, a fixed amount to reduce the stated price to be applied during and/or after the transaction, and/or the like). In some non-limiting aspects or embodiments, a loyalty program provider may be a merchant. In some non-limiting aspects or embodiments, the loyalty program provider system 112 may be included in the merchant system 108.

The network 114 may include one or more wired and/or wireless networks. For example, the network 114 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks illustrated by FIG. 1 are provided as an example. There may be additional devices, systems, and/or networks, fewer devices, systems, and/or networks, different devices, systems, and/or networks, or differently arranged devices, systems, and/or networks than those shown in FIG. 1. Furthermore, two or more devices or systems shown in FIG. 1 may be implemented within a single device or system, or a single device or system shown in FIG. 1 may be implemented as multiple, distributed devices or systems. Additionally or alternatively, a set of devices or systems (e.g., one or more devices or systems) of the system 100 for exchanging the transaction information when connections to a transaction service provider are unavailable may perform one or more functions described as being performed by another set of devices or systems of the system 100.

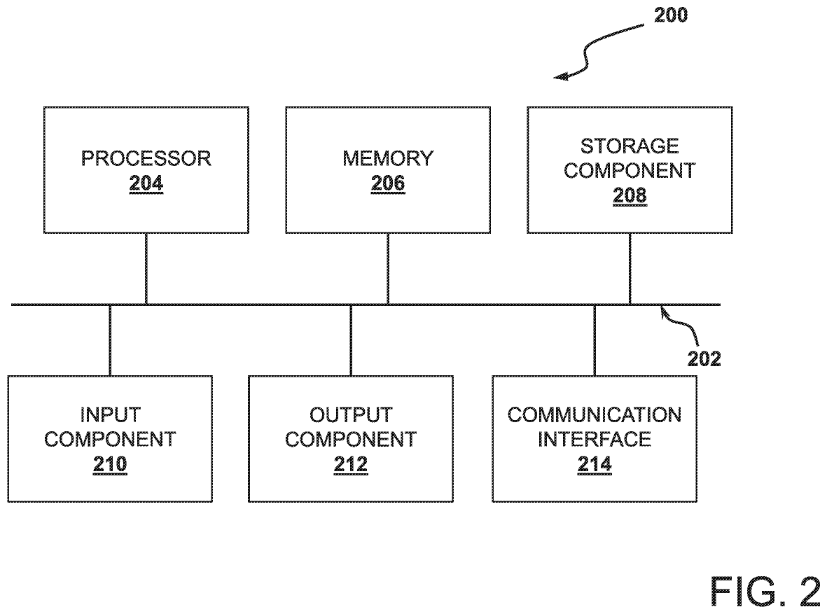

Referring now to FIG. 2, illustrated is a diagram of a computing device 200 having multiple components. The components described with regard to computing device 200 may correspond, all or in part, to components of one or more devices associated with the issuer system 102, payment device 104, POS device 106, merchant system 108, transaction service provider system 110, and loyalty program provider system 112. In some non-limiting aspects or embodiments, the issuer system 102, payment device 104, POS device 106, merchant system 108, transaction service provider system 110, and/or loyalty program provider system 112 may include at least one computing device 200 and/or one or more components of the computing device 200. As illustrated by FIG. 2, the computing device 200 may include a bus 202, a processor 204, memory 206, a storage component 208, an input component 210, an output component 212, and a communication interface 214.

The bus 202 may include a component that permits communication between the components of the computing device 200. In some non-limiting aspects or embodiments, the processor 204 may be implemented in hardware, firmware, or a combination of hardware and software. For example, the processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA) and/or an application-specific integrated circuit (ASIC), etc.) that can be programmed to perform one or more functions. The memory 206 may include random access memory (RAM), read-only memory (ROM), and/or another type of dynamic or static storage device (e.g., flash memory, magnetic memory, optical memory, etc.) that stores information and/or instructions for use and/or execution on the processor 204.

The storage component 208 may store information and/or software (e.g., executable instructions) related to the operation and use of the computing device 200. For example, the storage component 208 may include a hard disk (e.g., a magnetic disk, an optical disk, a magneto-optic disk, a solid state disk, etc.), a compact disk (CD), a digital versatile disc (DVD), a floppy disk, a cartridge, a magnetic tape, and/or another type of computer-readable medium, along with a corresponding drive.

The input component 210 may include a component that permits the computing device 200 to receive information, such as via user input (e.g., a touch screen display, a keyboard, a keypad, a mouse, a button, a switch, a microphone, etc.). Additionally or alternatively, the input component 210 may include a sensor for sensing information (e.g., a global positioning system (GPS) component, an accelerometer, a gyroscope, an actuator, etc.). The output component 212 may include a speaker, one or more light-emitting diodes (LEDs), etc.

The communication interface 214 may include a transceiver-like component (e.g., a transceiver, a separate receiver and transmitter, etc.) that enables the computing device 200 to communicate with other devices, such as via wired connections, wireless connections, or a combination of wired and wireless connections. The communication interface 214 may enable the computing device 200 to receive information from another device and/or provide information to another device. For example, the communication interface 214 may include an Ethernet interface, an optical interface, a coaxial interface, an infrared interface, a radio frequency (RF) interface, a universal serial bus (USB) interface, a WiFi® interface, a near-field communication (NFC) interface, a cellular network interface, and/or the like.

The computing device 200 may perform one or more processes described herein. For example, the computing device 200 may perform processes by executing software instructions on the processor 204. The software instructions may be stored in a computer-readable medium, such as memory 206 and/or the storage component 208. A computer-readable medium (e.g., a non-transitory computer-readable medium) is defined herein as a non-transitory memory device. A memory device includes memory space located inside of a single physical storage device or memory space spread across multiple physical storage devices.

The software instructions may be read into memory 206 and/or the storage component 208 from another computer-readable medium from another device via the communication interface 214. When executed, the software instructions stored in the memory 206 and/or the storage component 208 may cause the processor 204 to perform one or more processes described herein. Additionally or alternatively, hardwired circuitry may be used in place of, or in combination with, software instructions to perform one or more of the processes described herein. Thus, embodiments described herein are not limited to any specific combination of hardware circuitry and/or software.

The number and arrangement of components shown in FIG. 2 are provided as an example. In some non-limiting aspects or embodiments, the computing device 200 may include additional components, fewer components, different components, or differently arranged components than those shown in FIG. 2. Additionally or alternatively, a set of components (e.g., one or more components) of the computing device 200 may perform one or more functions described as being performed by another set of components of the computing device 200.

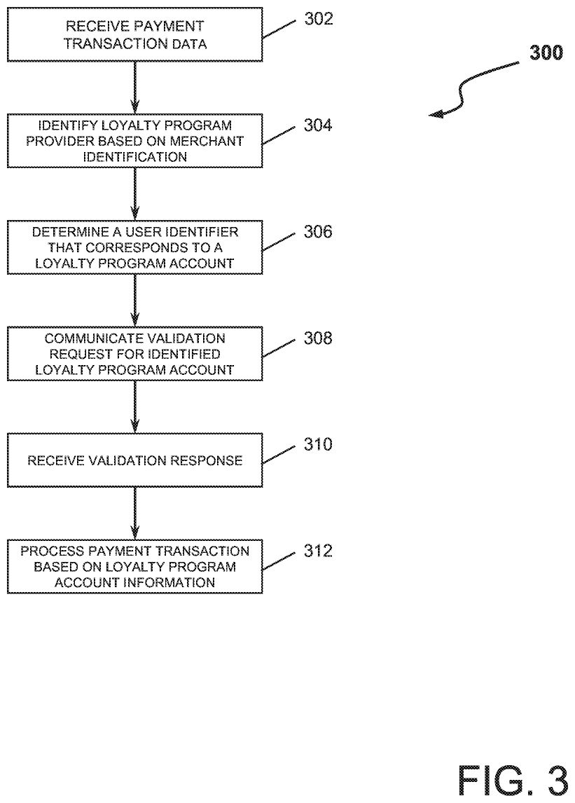

Referring now to FIG. 3, illustrated is a flow diagram of a process 300 for determining a loyalty program account at a POS device. In some non-limiting aspects or embodiments, one or more of the steps and/or operations of process 300, described herein, may be performed (e.g., completely, partially, etc.) by a transaction service provider system 110 (FIG. 1) (e.g., by and/or with one or more devices of the transaction service provider system 110). In some non-limiting aspects or embodiments, one or more of the steps and/or operations of process 300 may be performed (e.g., completely, partially, etc.) by another device and/or group of devices separate from or including the transactions service provider system 110 such as, without limitation, by the issuer system 102 (e.g., one or more devices of the issuer system 102), the payment device 104 (e.g., one or more devices of the payment device 104), the POS device 106 (e.g., one or more devices of the POS device 106), the merchant system 108 (e.g., one or more devices of the merchant system 108) and/or the loyalty program provider system 112 (e.g., one or more devices of the loyalty program provider system 112).

With continued reference to FIG. 3, process 300 includes receiving transaction data (e.g., a pre-authorization request and/or a payment authorization request) from the POS device 106 (e.g., a POS device) and/or the merchant system 108 at the transaction service provider system 110 (block 302). For example, when a payment transaction is initiated between a payment device 104 and a POS device 106 (e.g., when an user engages a POS terminal with a credit card), user identification data may be collected by the POS device 106 such as a payment account number (PAN) and/or other transaction data associated with, or maintained by, the payment device 104 (e.g., a payment token, a card verification code (CVC), an expiration date associated with the payment device 104, and/or the like).

In some non-limiting aspects or embodiments, the POS device 106 and/or the merchant system 108 may generate a pre-authorization request to communicate transaction data to the transaction service provider system 110. The pre-authorization request may be based on and/or include transaction data such as, without limitation, the user identification data, merchant identification data, data associated with goods and/or services to be exchanged during a transaction, a pre-authorization amount associated with the transaction amount, an upper-pre-authorization amount associated with the transaction amount, and/or the like. For example, in the case of automated fuel dispensing, a user may engage an automated fuel dispenser by inserting a credit card into a POS terminal of the automated fuel dispenser. The POS terminal may read user identification data stored in the credit card (e.g., a PAN, a payment token, a CVC code, and/or an expiration date) and, based on the user identification data, generate the pre-authorization request to be transmitted to the transaction service provider system 110. In some non-limiting aspects or embodiments, the pre-authorization amount may be a nominal value (e.g., one dollar) to verify that the payment device is an active and/or valid payment device 104 (e.g., is associated with an active account maintained by the issuer system 102), a pre-authorization limit (e.g., fifty-dollars) to which payment will be guaranteed in a case where the pre-authorization request is approved, and/or the like. In some non-limiting aspects or embodiments, the pre-authorization request may include merchant identification data such as a unique merchant identifier associated with the POS device 106 and/or the merchant system 108.

In some non-limiting aspects or embodiments, the pre-authorization request may be transmitted from the POS device 106 and/or the merchant system 108 to the transaction service provider system 110. The transaction service provider system 110 may, upon receipt of the pre-authorization request, analyze the pre-authorization request to identify a loyalty program provider associated with the pre-authorization request (block 304). The transactions service provider system 110 may, based on the merchant identification data received in the pre-authorization request, identify one or more loyalty program provider systems 112 associated with the merchant. In some non-limiting aspects or embodiments, the merchant identification data received by the transaction service provider system 110 in the pre-authorization request may be compared to a loyalty program provider index maintained by the transaction service provider system 110. The loyalty program provider index may include a table or other suitable data structure in which merchants are mapped to one or more loyalty program providers associated with one or more loyalty program provider systems 112 (e.g., merchant identifiers may be mapped to one or more loyalty program providers). When the merchant identification data is matched to one or more loyalty program providers maintained in the loyalty program provider index, the corresponding loyalty program provider or providers may be identified as the loyalty program provider for the particular merchant.

In some non-limiting aspects or embodiments, the transaction service provider system 110 may, upon receipt of the pre-authorization request, identify a user identifier associated with a loyalty program account (block 306). For example, the transaction service provider system 110 may compare the PAN received in the pre-authorization request to a user identifier index maintained by the transaction service provider system 110. The user identifier index may include a table or other suitable data structure in which PANs associated with users are mapped to a user identifier (e.g., a telephone number). When the PAN from the pre-authorization request is matched to a corresponding user identifier, the user identifier may be later transmitted to, and used by, the loyalty program provider system 112 to identify a loyalty program account, as will be discussed below.

In some non-limiting aspects or embodiments, loyalty program accounts may be initialized by a loyalty program provider system 112, prior to the initiation of the transaction at the POS device 106, to generate the one or more indexes of loyalty program accounts. For example, a user may register one or more PANs and/or user identifiers (e.g., phone numbers) with a loyalty program provider system 112 by transmitting registration data (e.g., the PAN or PANs, the phone number, a physical address, an email address, and/or the like), via a computing device controlled by the user, to the loyalty program provider system 112. In response to receipt of the registration data, the loyalty program provider system 112 may add or modify entries in the index of loyalty program accounts maintained by the loyalty program provider system 112. In some non-limiting aspects or embodiments, the entries in the index of loyalty program accounts may include mappings of user identifiers to loyalty program accounts. In some non-limiting aspects or embodiments, the loyalty program accounts may be associated with loyalty program account information that may include some or all of the registration data received during the registration of the loyalty program account by the user. In some non-limiting aspects or embodiments, the loyalty program provider system 112 may generate and/or update a user identifier index maintained by the loyalty program provider system 112. Entries in the user identifier index maintained by the loyalty program provider system 112 may correspond, in whole or in part, to entries in the user identifier index maintained by the transaction service provider system 110. In some non-limiting aspects or embodiments, correspondence between the user identifier indexes may be continuously or periodically verified by the transaction service provider system 110 and/or the loyalty program provider system 112 to add and/or remove entries in either or both of the user identifier indexes. In this way, PANs for users received by the transaction service provider system 110 may be matched to valid corresponding loyalty program accounts maintained by the loyalty program provider system 112.

The transaction service provider system 110 may transmit a validation request to the loyalty program provider system 112 (block 308). For example, to verify the PAN received in the pre-authorization request corresponds to a valid and/or active loyalty program account maintained by the loyalty program provider system 112, the transaction service provider system 110 may transmit the user identifier matched with the PAN at the transaction service provider system 110 to the loyalty program provider system 112 of the loyalty program provider associated with the merchant. The loyalty program provider system 112 may compare the user identifier to a loyalty program account index including a plurality of user identifiers and corresponding loyalty program accounts. Based on the comparison, the loyalty program provider system 112 may determine that the loyalty program account is valid or invalid.

In some non-limiting aspects or embodiments, when determining that the loyalty program account is valid, the loyalty program provider system 112 may determine that the loyalty program account exists in the index of loyalty program accounts maintained by the loyalty program provider system 112 and corresponds to loyalty program account information. In some non-limiting aspects or embodiments, the loyalty program account information may include transaction adjustment data (e.g., a percent reduction from a stated price to be applied during and/or after the transaction, a fixed amount to reduce the stated price to be applied during and/or after the transaction, and/or the like) and/or transaction history data (e.g., information associated with prior purchases, an accrued transaction value, an accrued transaction value that, when exceeded, causes a transaction adjustment to be applied to an instant and/or one or more subsequent transactions, and/or the like). The transaction history may be updated as transactions are processed by the transaction service provider system 110 (e.g., may be added to, removed from, or modified).

Additionally or alternatively, the loyalty program provider system 112 may determine that the loyalty program account does not exist and/or is no longer valid. For example, the loyalty program provider system 112 may compare the user identifier sent from the transaction service provider system 110 to be validated and may either not identify any entries that match the user identifier in the loyalty program account index maintained by the loyalty program provider system 112 and/or may identify a loyalty program account in the loyalty program account index that has expired or has otherwise been marked inactive (e.g., the merchant and/or loyalty program provider has disabled the loyalty program provider account, etc.).

Based on whether the loyalty program provider system 112 determines that the loyalty program account is valid or invalid, a validation response is generated by the loyalty program provider system 112 and transmitted to the transaction service provider system 110. The validation response may include an indication of validity, invalidity, inactivity, as well as the loyalty program account information associated with the loyalty program account. The transaction service provider system 110 may receive the validation response from the loyalty program provider system 112 (block 310). Based on the validation response the transaction service provider system 110 may process the payment transaction between the user and the merchant based on the loyalty program account information associated with the loyalty program account of the user (block 312). In some non-limiting aspects or embodiments, the transaction service provider system 110 may transmit the loyalty program account information to the merchant system 108 to enable the merchant system 108 to adjust the transaction data prior to the merchant system 108 forwarding the transaction data once the transaction is finalized. For example, the transaction service provider system 110 may receive an indication that the loyalty program account is valid and, based on the indication, process the transaction by adjusting and/or causing the merchant system 108 to adjust the price of the goods and/or services during the transaction. Adjustment may include, without limitation, reducing the prices of goods and/or services during the transaction in accordance with the transaction adjustment data associated with the loyalty program account information. In some non-limiting aspects or embodiments, the transaction service provider system 110 may forward final transaction details (e.g., transaction details such as a final transaction price, date, time, quantity of goods and/or services purchased, etc. that are submitted for settlement with an issuer institution during the transaction) to the loyalty program provider system 112 once the transaction is processed.

In some non-limiting aspects or embodiments, the validation response received by transaction service provider system 110 from the loyalty program provider system 112 may include an indication that the loyalty program account is not valid (e.g., does not exist, has expired, etc.). In some non-limiting aspects or embodiments, the transaction service provider system 110 may, in response to receiving the indication that the loyalty program account is not valid, forward the indication that the loyalty program account is not valid in a pre-authorization response transmitted to the merchant system 108 and/or the POS device 106. In some non-limiting aspects or embodiments, the transaction service provider system 110 may, based on receiving the validation response indicating that the loyalty program account is not valid, transmit instructions and/or an indication to cause the POS device 106 to output an indication, via a display of the POS device 106, that a loyalty program account is not valid. In some non-limiting aspects or embodiments, the displayed indication may prompt the user to register a loyalty program account with the loyalty program provider system 112. In some non-limiting aspects or embodiments, in response to input by the user at the POS device 106 indicating that the user would like to register for a loyalty program account, the POS device 106 may display a quick response (QR) code to be captured by an input device managed by the user (e.g., with a camera of a mobile phone) for registration after the transaction is completed. In some non-limiting aspects or embodiments, the POS device 106 may display a Uniform Resource Locator (URL), instructions or an address to download an application, a unique code associated with the transaction, and/or the like. In some non-limiting aspects or embodiments, the POS device 106 may display limiting conditions such as, a registration time limit (e.g., how long registration of the instant transaction with a loyalty program account is available), and/or other incentives (e.g., benefits associated with registering the instant transaction with a new loyalty program account. In some non-limiting aspects or embodiments, registration information (e.g., information to register with the loyalty program provider such as a registration website, a registration phone number, etc.) may be included on a receipt that is printed and/or transmitted to the user from the merchant system 108 and/or the transaction service provider system 110 via email. In some non-limiting aspects or embodiments, the POS device 106 may, upon display of an indication to prompt the user to register a loyalty program account with the loyalty program provider system 112, receive input to register a loyalty program account. The input may be forwarded to the transaction service provider system 110 and/or the loyalty program provider system 112 to cause the loyalty program provider system 112 to register a loyalty program account for the user. In response to registration, the merchant system 108 and/or the transaction service provider system 110 may receive transaction adjustment data from the loyalty program provider system 112 and, based on the transaction adjustment data, adjust the transaction data (e.g., reduce the cost of the transaction).

In some non-limiting aspects or embodiments, the merchant and/or the user may be associated with multiple loyalty program providers, and by extension, users engaging in transactions with the merchant may be permitted to choose to associate a particular loyalty program provider that the user is registered with. When the transaction service provider system 110 identifies multiple available loyalty program providers (e.g., that the merchant controlling the AFD is associated with a merchant that is a grocery store and a merchant that is a sporting goods store), the transaction service provider system 110 may forward the user identifier to some or all of the corresponding loyalty program provider systems 112. In response to responses from the multiple loyalty program provider systems 112 indicating that valid loyalty program accounts exist (e.g., in response to receiving multiple sets of loyalty program account information), the transaction service provider system 110 may include the multiple sets of loyalty program account information in the pre-authorization response sent to the merchant system 108. In some non-limiting aspects or embodiments, the merchant system 108 may then cause the POS terminal 106 to display, on a display of the POS terminal 106, an option to select a loyalty program account to associate with the transaction from among the multiple loyalty program accounts available. In response to receiving input selecting one or more loyalty program accounts at the POS terminal 106, the merchant system 108 and/or the transaction service provider system 110 may use corresponding transaction adjustment data associated with the selected loyalty program provider account or accounts and apply a corresponding transaction adjustment to the transaction. In some non-limiting aspects or embodiments, the POS terminal 106 may display an option to select a loyalty program provider from among one or more predetermined loyalty program providers, and in response to receiving input at the POS terminal 106 indicating selection of a loyalty program provider, forward the input to the transaction service provider system 110. The transaction service provider system 110 may, in response to receiving the input indication selection of a loyalty program provider, identify a loyalty account identifier based on the provided indication and the transaction data associated with the pre-authorization request. As a result, in the case where multiple loyalty program accounts are associated with a merchant and a customer, a confirmation request need not be transmitted to verify which loyalty program provider should be associated with the transaction and, in turn, the need for additional communication between the POS terminal 106 and the transaction service provider system 110 to confirm which loyalty program provider should be associated with the transaction may be reduced.

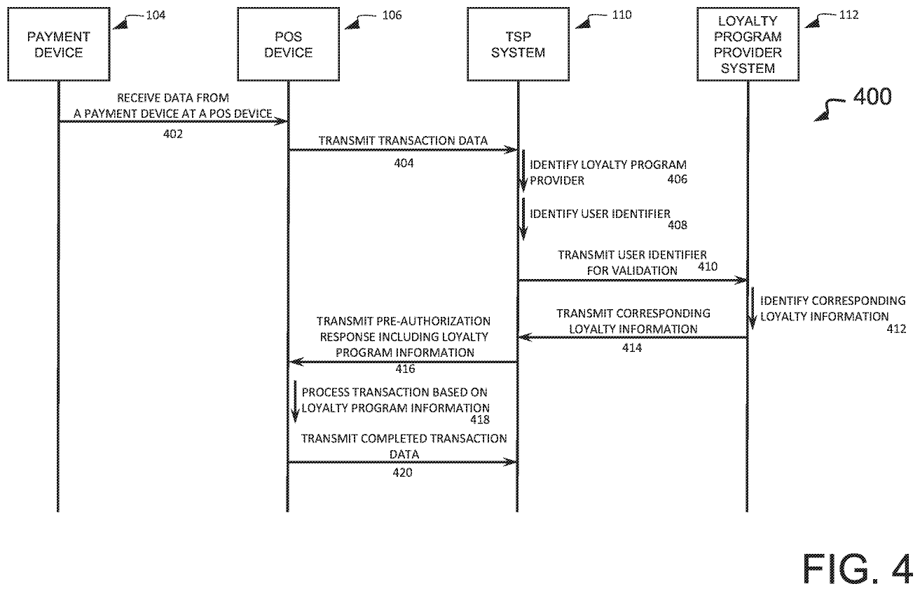

Referring now to FIG. 4, illustrated is a diagram of an implementation of non-limiting aspects or embodiments of a process 400 for determining a loyalty program account at a POS device. In some non-limiting aspects or embodiments, one or more of the steps and/or operations of process 400 may be performed (e.g., completely, partially, etc.) by some or all of the components discussed with respect to FIG. 1, above (e.g., the payment device 104, the POS device 106, the merchant system 108, the transaction service provider system 110, the loyalty program provider system 112, and/or the issuer system 102. In some non-limiting aspects or embodiments, one or more of the steps and/or operations of process 400 may be performed (e.g., completely, partially, etc.) by another device or a group of devices, for example, those described above with respect to FIG. 1.

As illustrated in FIG. 4, initially a POS device 106 receives data from a payment device 104 (402). For example, a POS device 106 such as a POS terminal may receive a payment device 104 such as a credit card or electronic wallet, and read information from the payment device 104 (e.g., a PAN associated with the payment device, a payment token, etc.). The POS device 106 may, upon receipt of the information from the payment device 104, transmit transaction data to initiate processing of a payment transaction at a transaction service provider system 110 (404). For example, a pre-authorization request may be generated by the POS device 106 including the PAN associated with the payment device 104, a transaction value associated with the goods and/or services to be purchased, a merchant identifier, and/or like data. In some non-limiting embodiments, may transmit the information received from the payment device 104 to the merchant system 108 for transmission to the transaction service provider system 110. In some non-limiting embodiments the merchant system 108 may generate the pre-authorization request. The transaction service provider system 110 may, based on the pre-authorization request received from the POS device 106, identify a loyalty program provider (406). For example, the transaction service provider system 110 may compare the merchant identifier from the pre-authorization request to an index of merchant identifiers mapped to loyalty program provider identifiers, each loyalty program provider identifier corresponding to a loyalty program provider system 112. Additionally, the transaction service provider system 110 may identify a user identifier (408). For example, the transaction service provider system 110 may compare the PAN from the pre-authorization request to an index of PANs mapped to user identifiers associated with loyalty program accounts such as, without limitation, user phone numbers and/or like other unique identifiers.

The transaction service provider system 110 may transmit the user identifier to a loyalty program provider system 112 to verify or otherwise validate the user identifier corresponding to the PAN received in the pre-authorization request (410). In response, the loyalty program provider system 112 may compare the user identifier to an index of user identifiers mapped to loyalty program accounts stored in the memory of the loyalty program provider system 112 as loyalty program account data (412). The loyalty program provider system 112 may transmit a validation response from the loyalty program provider system 112 to the transaction service provider system 110 (414). In some non-limiting aspects or embodiments, the validation response may include an indication as to whether the loyalty program account corresponding to the user identifier exists, is active, is inactive, has been deactivated, does not exist, and/or the like. In some non-limiting aspects or embodiments, the validation response may include loyalty program account data such as, without limitation, transaction adjustment data to be used to adjust the price of the transaction by either the transaction service provider system 110 and/or the POS device 106.

The transaction service provider system 110 may transmit a pre-authorization response to the POS device 106 indicating that the transaction is authorized or is not authorized (416). For example, In some non-limiting aspects or embodiments, prior to transmission of the pre-authorization response, the transaction service provider system 110 may communicate with an issuer system 102 to determine whether sufficient funds are available to complete the transaction (e.g., whether there are sufficient funds available to satisfy the transaction amount requested for the transaction in the pre-authorization request). Once the issuer system 102 communicates to the transaction service provider system 110 that sufficient funds are available, the transaction service provider system 110 may prepare a transaction authorization response indicating that the funds are available. In some non-limiting aspects or embodiments, the transaction service provider system 110 may also include an indication that the loyalty program provider system 112 associated with the merchant system 108 does or does not include a loyalty program account corresponding to the PAN received in the pre-authorization request. Where the loyalty program provider system 112 indicates that a loyalty program account is valid, transaction adjustment data may also be transmitted by the transaction service provider system 110 in the pre-authorization response to the POS device 106.

In some non-limiting aspects or embodiments, upon receipt of the transaction authorization response indicating that sufficient funds are available, the price may be adjusted prior to or after the transaction is executed. For example, the POS terminal 106 and/or the merchant system 108

The POS device 106 may process the transaction in response to receiving the pre-authorization response from the transaction service provider system 110 (418). For example, the merchant system 108 may adjust the price of the goods and/or services purchased by reducing the price of some or all of the goods and/or services subject to the transaction and display the reduced price on a display of the POS device 106. The adjustment to the price by the merchant system 108 may occur prior to or after goods are dispensed at the POS device 106, based on receiving the loyalty program account information in the pre-authorization response. Additionally, or alternatively, adjustment of the price of the goods may occur at the POS device 106 either prior to or after the POS device 106 dispenses the goods and/or services. In some non-limiting aspects or embodiments, the price of the goods and/or services may be adjusted at the transaction service provider system 110 prior to communication between the transaction service provider system 110 and the issuer system 102 during transaction settlement.

In some non-limiting aspects or embodiments, based on a determination made by the loyalty program provider system 112 and/or the transaction service provider system 110 that a valid loyalty program account is not associated with the PAN received in the pre-authorization request, the POS device 106 may display an indication declining the transaction. For example, a merchant that requires customers to first register with the merchant (e.g., first register with the merchant via a membership club) may, in a case where a valid loyalty program account is not identified, determine that the payment device 104 is not associated with a registered member and, as a result, may not be used to complete the transaction. In some non-limiting aspects or embodiments, the merchant system 108 may cause the POS device 106 to display an indication as to why the transaction was declined. For example, the merchant system 108 may cause the POS device 106 to display the indication as text associated with a reason as to why the transaction was declined, such as “THE CARD USED IS NOT ASSOCIATED WITH A VALID MEMBERSHIP.” In some non-limiting aspects or embodiments, the POS device 106 may display an indication to prompt a user to register for a membership with the merchant system 108 and/or the loyalty program provider system 112.

Once the merchant system 108 and/or the POS device 106 finalize the transaction, the merchant system 108 may communicate a final transaction message including final transaction data to the transaction service provider system 110 (420). For example, in some non-limiting aspects or embodiments, the POS device 106 may transmit completed transaction data such as, without limitation, transaction data associated with the pre-authorization request and/or the pre-authorization response, a final transaction price, and/or like data. Once received, the transaction service provider system 110 may settle the transaction (e.g., by brokering a currency exchange between the issuer system 102 associated with the payment device 104 and a bank or other institution associated with the merchant system 108 (e.g., an acquirer system associated with the merchant system 108).

Although the present disclosure has been described in detail for the purpose of illustration based on what is currently considered to be the most practical and preferred embodiments, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method for determining a loyalty program account at a point-of-sale (POS) device, the method comprising:
receiving, with at least one processor, payment transaction data associated with a payment transaction during the payment transaction between a user and a merchant;
identifying, with at least one processor, a loyalty program provider associated with the merchant based on receiving merchant identification data associated with an identification of the merchant included in the payment transaction data associated with the payment transaction;
determining, with at least one processor, a user identifier that identifies a loyalty program account of the user based on a payment account number of a payment account of the user included in the payment transaction data associated with the payment transaction;
communicating, with at least one processor, a request for validation of the loyalty program account of the user based on identifying the loyalty program provider associated with the merchant, the request for validation including the user identifier;
receiving, with at least one processor, an indication that the loyalty program account of the user is valid and loyalty program account information associated with the loyalty program account of the user based on the request for validation of the loyalty program account of the user; and
processing, with at least one processor, the payment transaction between the user and the merchant based on the loyalty program account information associated with the loyalty program account of the user.

2. The method according to claim 1, further comprising:
receiving the user identifier that identifies the loyalty program account of the user from a user device associated with the user before the payment transaction between the user and the merchant;
assigning the user identifier that identifies the loyalty program account of the user to the payment account number of the payment account of the user; and
storing the user identifier that identifies the loyalty program account of the user with the payment account number of the payment account of the user in a database.

3. The method according to claim 1, wherein the user is a first user, the method further comprising:
determining that a loyalty program account of a second user is not available based on receiving the payment transaction data associated with a payment transaction; and
communicating a message to a merchant system, wherein the message comprises a first indication that a loyalty program account of the second user is not available and a second indication that includes enrollment information associated with establishing a loyalty program account of the second user.

4. The method according to claim 1, wherein determining the user identifier that identifies the loyalty program account of the user comprises:
determining the user identifier that identifies the loyalty program account of the user independent of information associated with an input received based on a manual input component of a POS device.

5. The method according to claim 1, further comprising:
receiving an indication that the loyalty program account of the user is not valid based on the request for validation of the loyalty program account of the user; and
processing the payment transaction between the user and the merchant independent of the loyalty program account information associated with the loyalty program account of the user.

6. The method according to claim 5, wherein processing the payment transaction between the user and the merchant comprises:
communicating an authorization request message to an issuer system, wherein the authorization request message is independent of the loyalty program account information associated with the loyalty program account of the user.

7. The method according to claim 1, further comprising:
receiving an indication that the loyalty program account of the user is not valid based on the request for validation of the loyalty program account of the user; and
declining to process the payment transaction between the user and the merchant based on receiving the indication that the loyalty program account of the user is not valid.

8. A system for determining a loyalty program account at a point-of-sale (POS) device, the system comprising:
at least one processor programmed or configured to:
receive payment transaction data associated with a payment transaction during the payment transaction between a user and a merchant;
identify a loyalty program provider associated with the merchant based on receiving merchant identification data associated with an identification of the merchant included in the payment transaction data associated with the payment transaction;
determine a user identifier that identifies a loyalty program account of the user based on a payment account number of a payment account of the user included in the payment transaction data associated with the payment transaction;
communicate a request for validation of the loyalty program account of the user based on identifying the loyalty program provider associated with the merchant, the request for validation including the user identifier;
receive an indication that the loyalty program account of the user is valid and loyalty program account information associated with the loyalty program account of the user based on the request for validation of the loyalty program account of the user; and
process the payment transaction between the user and the merchant based on the loyalty program account information associated with the loyalty program account of the user.

9. The system according to claim 8, wherein the at least one processor is further programmed or configured to:
receive the user identifier that identifies the loyalty program account of the user from a user device associated with the user before the payment transaction between the user and the merchant;
assign the user identifier that identifies the loyalty program account of the user to the payment account number of the payment account of the user; and
store the user identifier that identifies the loyalty program account of the user with the payment account number of the payment account of the user in a database.

10. The system according to claim 8, wherein, the user is a first user, and the at least one processor is programmed or configured to:
determine that a loyalty program account of a second user is not available based on receiving the payment transaction data associated with a payment transaction; and
communicate a message to a merchant system, wherein the message comprises a first indication that a loyalty program account of the second user is not available and a second indication that includes enrollment information associated with establishing a loyalty program account of the second user.

11. The system according to claim 8, wherein, when determining the user identifier that identifies the loyalty program account of the user, the at least one processor is programmed or configured to:
determine the user identifier that identifies the loyalty program account of the user independent of information associated with an input received based on a manual input component of a POS device.

12. The system according to claim 8, wherein the at least one processor is programmed or configured to:
receive an indication that the loyalty program account of the user is not valid based on the request for validation of the loyalty program account of the user; and
process the payment transaction between the user and the merchant independent of the loyalty program account information associated with the loyalty program account of the user.

13. The system according to claim 12, wherein, when processing the payment transaction between the user and the merchant, the at least one processor is programmed or configured to:
communicate an authorization request message to an issuer system, wherein the authorization request message is independent of the loyalty program account information associated with the loyalty program account of the user.

14. The system according to claim 8, wherein the at least one processor is programmed or configured to:
receive an indication that the loyalty program account of the user is not valid based on the request for validation of the loyalty program account of the user; and
decline to process the payment transaction between the user and the merchant based on receiving the indication that the loyalty program account of the user is not valid.

15. A computer program product for determining a loyalty program account at a point-of-sale (POS) device, comprising at least one non-transitory computer-readable medium including one or more instructions that, when executed by at least one processor, cause the at least one processor to:
receive payment transaction data associated with a payment transaction during the payment transaction between a user and a merchant;
identify a loyalty program provider associated with the merchant based on receiving merchant identification data associated with an identification of the merchant included in the payment transaction data associated with the payment transaction;
determine a user identifier that identifies a loyalty program account of the user based on a payment account number of a payment account of the user included in the payment transaction associated with the payment transaction;
communicate a request for validation of the loyalty program account of the user based on identifying the loyalty program provider associated with the merchant, the request for validation including the user identifier;
receive an indication that the loyalty program account of the user is valid and loyalty program account information associated with the loyalty program account of the user based on the request for validation of the loyalty program account of the user; and
process the payment transaction between the user and the merchant based on the loyalty program account information associated with the loyalty program account of the user.

16. The computer program product according to claim 15, wherein the one or more instructions, when executed by the at least one processor, further cause the at least one processor to:
receive the user identifier that identifies the loyalty program account of the user from a user device associated with the user before the payment transaction between the user and the merchant;
assign the user identifier that identifies the loyalty program account of the user to the payment account number of the payment account of the user; and
store the user identifier that identifies the loyalty program account of the user with the payment account number of the payment account of the user in a database.

17. The computer program product according to claim 15, wherein the user is a first user, and
wherein the one or more instructions, when executed by the at least one processor, further cause the at least one processor to:
determine that a loyalty program account of a second user is not available based on receiving the payment transaction data associated with the payment transaction; and
communicate a message to a merchant system, wherein the message comprises a first indication that the loyalty program account of the second user is not available and a second indication that includes enrollment information associated with establishing the loyalty program account of the second user.

18. The computer program product according to claim 15, wherein the one or more instructions that cause the at least one processor to receive data, cause the at least one processor to:
determine the user identifier that identifies the loyalty program account of the user independent of information associated with an input received based on a manual input component of a POS device.

19. The computer program product according to claim 15, wherein the one or more instructions, when executed by the at least one processor, further cause the at least one processor to:
receive an indication that the loyalty program account of the user is not valid based on the request for validation of the loyalty program account of the user; and
process the payment transaction between the user and the merchant independent of the loyalty program account information associated with the loyalty program account of the user.

20. The computer program product according to claim 19, wherein the one or more instructions that cause the at least one processor to process the payment transaction between the user and the merchant cause the at least one processor to:
communicate an authorization request message to an issuer system, wherein the authorization request message is independent of the loyalty program account information associated with the loyalty program account of the user.

21. The computer program product according to claim 15, wherein the one or more instructions, when executed by the at least one processor, further cause the at least one processor to:
receive an indication that the loyalty program account of the user is not valid based on the request for validation of the loyalty program account of the user; and
decline to process the payment transaction between the user and the merchant based on receiving the indication that the loyalty program account of the user is not valid.
